(19) United States
(12) Patent Application Publication
(10) Pub. No.: US 2026/0292231 A1
(43) Pub. Date: Sep. 24, 2026

(54) Methods and Apparatus for Adaptive inter Cross-Component Prediction for Chroma Coding

(71) Applicant: MEDIATEK INC., Hsinchu City (TW)

(72) Inventors: Hsin-Yi TSENG, Hsinchu City (TW); Man-Shu CHIANG, Hsinchu City (TW); Chia-Ming TSAI, Hsinchu City (TW); Cheng-Yen CHUANG, Hsinchu City (TW); Chih-Wei HSU, Hsinchu City (TW); Yi-Wen CHEN, San Jose, CA (US)

(21) Appl. No.: 19/472,638

(22) PCT Filed: Jul. 5, 2024
(86) PCT No.: PCT/CN2024/104013

§ 371 Date: Oct. 4, 2025

Related U.S. Application Data
(60) Provisional application No. 63/511,922, filed on Jul. 5, 2023.

(51) Int. Cl. H04N 19/503; H04N 19/105; H04N 19/176; H04N 19/186; H04N 19/593; H04N 19/70

(52) U.S. Cl. CPC H04N 19/503; H04N 19/105; H04N 19/176; H04N 19/186; H04N 19/593; H04N 19/70

(57) ABSTRACT

A method and apparatus for coding colour pictures using coding tools including one or more cross component models related modes are disclosed. According to this method, whether to code the second-colour block using inter CCP (Cross-Component Prediction) is determined. In response to the inter CCP being not applied to the second-colour block: the second-colour block is encoded or decoded using regular inter/IBC prediction without cross-component information. In response to the inter CCP being applied to the second-colour block: a candidate list comprising one or more cross-component model candidates is derived; and the second-colour block is encoded or decoded using information comprising the candidate list, wherein if one or more target cross-component model candidates are selected for the second-colour block, prediction data for the second-colour block is generated by applying one or more corresponding cross-component models associated with said one or more target cross-component model candidates to the first-colour block.

### CROSS REFERENCE TO RELATED APPLICATIONS

The present invention is a non-Provisional Application of and claims priority to U.S. Provisional Patent Application No. 63/511,922, filed on Jul. 5, 2023. The U.S. Provisional Patent Application is hereby incorporated by reference in its entirety.

### FIELD OF THE INVENTION

The present invention relates to video coding system. In particular, the present invention discloses adaptive inter cross-component prediction and adjusted prediction for chroma components.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology—Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, is provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

The VVC standard incorporates various new coding tools to further improve the coding efficiency over the HEVC standard. Some new tools relevant to the present invention are reviewed as follows.

In order to improve the coding performance for a system using cross-component models, methods and apparatus of applying inter cross-component prediction (interCCP) or adjusted prediction to the chroma component adaptively are disclosed.

### BRIEF SUMMARY OF THE INVENTION

A method and apparatus for coding colour pictures using coding tools including one or more cross component models related modes are disclosed. According to this method, input data associated with a current block comprising a first-colour block and a second-colour block is received, wherein the input data comprises pixel data to be encoded at an encoder side or data associated with the current block to be decoded at a decoder side. Whether to code the second-colour block using inter CCP (Cross-Component Prediction) is determined. In response to the inter CCP being not applied to the second-colour block: the second-colour block is encoded or decoded using regular inter prediction or regular IBC prediction without cross-component information. In response to the inter CCP being applied to the second-colour block: a candidate list comprising one or more cross-component model candidates is derived; and the second-colour block is encoded or decoded using information comprising the candidate list, wherein if one or more target cross-component model candidates are selected for the second-colour block, prediction data for the second-colour block is generated by applying one or more corresponding cross-component models associated with said one or more target cross-component model candidates to the first-colour block.

In one embodiment, when the inter CCP is applied to the second-colour block, the first-colour block is coded in the regular inter prediction or in the regular IBC prediction without the cross-component information.

In one embodiment, the inter CCP corresponds to inter CCLM (Cross-Component Linear Model) or inter CCCM (Convolutional Cross-Component Model).

In one embodiment, whether to code the second-colour block using the inter CCP is indicated by signalling. In one embodiment, said signalling refers to a flag in TU, TB, CU or CB level. In one embodiment, the flag is signalled only when Cbf (Coding block flag) is non-zero and an enabling flag for the inter or IBC (Intra Block Copy) mode is true. In one embodiment, the coded flag is coded using one or more contexts.

In one embodiment, when the inter CCP is applied to the second-colour block, additional signalling is used to select said one or more target cross-component model candidates from the candidate list. In one embodiment, when multiple target cross-component model candidates are selected, the prediction data for the second-colour block is generated by blending corresponding multiple cross-component models associated with the multiple target cross-component model candidates. In one embodiment, the additional signalling corresponds to using an index coded by truncated unary coding with or without context.

In one embodiment, the inter CCP is signalled or parsed only when one or more size conditions of the current block are satisfied. In one embodiment, said one or more size conditions of the current block comprise block width, block height, or block area being larger or smaller than a pre-defined threshold.

In one embodiment, when the inter CCP is applied to the second-colour block, said one or more target cross-component model candidates from the candidate list are determined implicitly or according to one or more rules. In one embodiment, at least one of CCLM_LT (Cross-Component Linear Model with Left and Top templates), MMLM_LT (Multi-Mode CCLM with Left and Top templates), and CCCM_LT (Convolutional Cross-Component Model with Left and Top templates) is always used as said one or more target cross-component model candidates. In one embodiment, said one or more rules are determined depending on block width, block height, or block area. In another embodiment, said one or more rules are determined depending on boundary matching.

In one embodiment, one target cross-component model candidate is selected from the candidate list, and the prediction data is blended with second prediction data corresponding to an angular or planar mode to form final prediction data for the second-colour block. In one embodiment, an index is signalled or parsed to indicate said one target cross-component model candidate selected from the candidate list.

In one embodiment, whether the inter CCP is used in the current block is determined depending on an enabling flag. In one embodiment, the enabling flag is signalled or parsed in a bitstream, or is inferred. In one embodiment, whether to signal or parse the enabling flag is determined dependent on block width, block height, or block area. In one embodiment, the enabling flag is regular merge flag when the current block is coded in a regular merge mode. In one embodiment, the enabling flag is CUP (Combined biter and Intra Prediction) flag when the current block is coded in a CIIP mode. In one embodiment, the enabling flag is CIIP PDPC (Position Dependent Prediction Combination) flag when the current block is coded in a CIP PDPC mode.

In one embodiment, a combined predictor for the second-colour block is derived by combining at least one of the regular inter prediction and the regular IBC prediction with the prediction data from inter CCP, wherein said at least one of the regular inter prediction and the said regular IBC prediction is adjusted based on neighbouring data and pre-defined weighting before said combining said at least one of the regular inter prediction and the regular IBC prediction with the prediction data from the inter CCP. In one embodiment, the pre-defined weighting follows PDPC (Position Dependent Prediction Combination) weighting.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 shows 16 gradient patterns for GLM.

FIG. 3 shows an exemplary system block diagram for Cross-component residual model (CCRM).

FIG. 4 illustrates an example of template and its reference samples used in TIMD.

FIG. 5 illustrates the 5 neighbouring blocks used for deriving spatial merge candidates for VVC.

FIG. 6 illustrates an exemplary pattern of the non-adjacent spatial merge candidates.

FIG. 7 illustrates an example of temporal candidate derivation, where a scaled motion vector is derived according to POC (Picture Order Count) distances.

FIG. 8 illustrate the positions for the temporal candidate selected between candidates C₀ and C₁.

FIG. 9 illustrates an example of the reference region to derive proposed weighting setting according to an embodiment of the present invention.

FIG. 10 illustrates an example of PDPC further used to adjust the predictors for the current block.

FIG. 11 illustrates an example of inheriting temporal neighbouring model parameters.

FIGS. 12A-B illustrates two search patterns for inheriting non-adjacent spatial neighbouring models.

FIG. 13 illustrates an example to map motion information for the to-be referenced positions in a non-available region to pre-defined positions, where the pre-defined positions are located at one line above the above-first CTU row.

FIG. 14 illustrates an example to map motion information for the to-be referenced positions in a non-available region to pre-defined positions, where the pre-defined positions are located at the bottom line of respective CTU rows.

FIG. 15 illustrates an example to map motion information for the to-be referenced positions in a non-available region to pre-defined positions, where the pre-defined positions are located at the bottom line or the centre line of respective CTU rows.

FIG. 16 illustrates an example to map motion information for the to-be referenced positions in a non-available region to pre-defined positions, where the pre-defined positions are located at the bottom line of respective CTU rows or one CTU row above the respective CTU rows.

FIG. 17 illustrates a flowchart of an exemplary video coding system that uses interCCP (inter Cross-Component Prediction) adaptively for chroma coding according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

### Cross-Component Linear Model (CCLM) Prediction

To reduce the cross-component redundancy, a cross-component linear model (CCLM) prediction mode is used in the VVC, for which the chroma samples are predicted based on the reconstructed luma samples of the same CU by using a linear model as follows:

$${pred}_{C} ( i , j ) = α \cdot {rec}_{L}^{′} ( i , j ) + β \qquad ( 1 )$$

where pred_{C}(i, j) represents the predicted chroma samples in a CU and rec_{L}′(i, j) represents the downsampled reconstructed luma samples of the same CU.

The CCLM parameters (α and β) are derived with at most four neighbouring chroma samples and their corresponding down-sampled luma samples. Suppose the current chroma block dimensions are W×H, then W′ and H′ are set as
W′=W, H′=H when LM_LA mode is applied;
W′=W+H when LM_A mode is applied,
H′=H+W when LM_L mode is applied.

The terms of {LM_LA, LM_L, LM_A} and {CCLM_LT, CCLM_L, CCLM_T} are used interchangeably in this disclosure.

### Multiple Model CCLM (MMLM)

In the JEM (J. Chen, E. ALshina, G. J. Sullivan, J.-R. Ohm, and J. Boyce, Algorithm Description of Joint Exploration Test Model 7, document JVET-G1001, ITU-T/ISO/IEC Joint Video Exploration Team (JVET), July 2017), multiple model CCLM mode (MMLM) is proposed for using two models for predicting the chroma samples from the luma samples for the whole CU. In MMLM, neighbouring luma samples and neighbouring chroma samples of the current block are classified into two groups, each group is used as a training set to derive a linear model (i.e., a particular α and, β are derived for a particular group). Furthermore, the samples of the current luma block are also classified based on the same rule for the classification of neighbouring luma samples.

Threshold is calculated as the average value of the neighbouring reconstructed luma samples. A neighbouring sample with Rec′_{L}[x, y]<=Threshold is classified into group 1; while a neighbouring sample with Rec′_{L}[x,y]>Threshold is classified into group 2.

$$\{ \begin{matrix}{Pred}_{C} [ x , y ] = {α}_{1} \times {Rec}_{L}^{′} [ x , y ] + {β}_{1} & if {Rec}_{L}^{′} [ x , y ] \leq Threshold \\ {Pred}_{C} [ x , y ] = {α}_{2} \times {Rec}_{L}^{′} [ x , y ] + {β}_{2} & if {Rec}_{L}^{′} [ x , y ] > Threshold\end{matrix} \qquad ( 2 )$$

### Local Illumination Compensation (LIC)

Local Illumination Compensation (LIC) is a method to do inter predict by using neighbour samples of current block and reference block. It is based on a linear model using a scaling factor a and an offset b. It derives the scaling factor a and an offset b by referring to the neighbour samples of current block and reference block. Moreover, it's enabled or disabled adaptively for each CU.

For more detail for LIC, it can refer to the document JVET-C1001 (Jianle Chen, et al., “Algorithm Description of Joint Exploration Test Model 3”, Joint Video Exploration Team (JVET) of ITU-T SG 16 WP 3 and ISO/IEC JTC 1/SC 29/WG 11, 3rd Meeting: Geneva, CH, 26 May-1 Jun. 2016, Document: JVET-C1001).

### Convolutional Cross-Component Model (CCCM)

In CCCM, a convolutional model is applied to improve the chroma prediction performance. The convolutional model has 7-tap filter consisting of a 5-tap plus sign shape spatial component, a nonlinear term and a bias term.

Output of the filter is calculated as a convolution between the filter coefficients and the input values and clipped to the range of valid chroma samples.

The filter coefficients are calculated by minimising MSE between predicted and reconstructed chroma samples in the reference area.

The MSE minimization is performed by calculating autocorrelation matrix for the huma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations.

### Gradient Linear Model (GLM)

Compared with the CCLM, instead of down-sampled luma values, the GLM utilizes luma sample gradients to derive the linear model. Specifically, when the GLM is applied, the input to the CCLM process, i.e., the down-sampled luma samples L, are replaced by luma sample gradients G. The other parts of the CCLM (e.g., parameter derivation, prediction sample linear transform) are kept unchanged:

$$C = α \cdot G + β .$$

For signalling, when the CCLM mode is enabled for the current CU, two flags are signalled separately for Cb and Cr components to indicate whether GLM is enabled for each component; if the GLM is enabled for one component, one syntax element is further signalled to select one of 16 gradient filters (210-240) for the gradient calculation as shown in FIG. 2. The GLM can be combined with the existing CCLM by signalling one extra flag in bitstream. When such combination is applied, the filter coefficients that are used to derive the input luma samples of the linear model are calculated as the combination of the selected gradient filter of the GLM and the down-sampling filter of the CCLM.

### Intra Block Copy

Intra block copy (IBC) is a tool adopted in HEVC extensions on screen content coding (SCC). It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector is rounded to integer precision as well. When combined with AMVR, the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

### Cross-Component Residual Model (CCRM)

As in JVET-AD0108 (Pekka Astola, et. al., “AHG12: Cross-component residual model (CCRM) for inter prediction”. Joint Video Experts Team (JVET) of ITU-T SG 16 WP 3 and ISO/IEC JTC 1/SC 29, 30th Meeting, Antalya, TR, 21-28 Apr. 2023, Document: JVET-AD0108), it is to apply cross-component residual model (CCRM) to predict chroma samples from reconstructed luma samples when the block uses inter prediction or intra block copy (BC). FIG. 3 illustrates the decoder side of the method. The cross-component filters are derived using the prediction signals of luma and chroma. The derived filters are applied to the reconstructed luma signal producing the final chroma predictions. The input to the filter consists of 6 spatial luma samples, a nonlinear term, and a bias term. Filter coefficients are derived in step 320 for each block separately using the prediction signals (i.e., predY 310, predCb 312 and predCr 314) and the filters are applied to the reconstructed luma signal in step 330 as shown in FIG. 3. The reconstructed luma signal is formed by combining the luma prediction (PredY) 310 and residual luma signal (resY) using an adder 322. After applying the filters, the step 330 generates filtered-predicted Cb 340 and filtered-predicted Cr 350. The reconstructed Cb signal is formed by combining the filtered-predicted Cb 340 and residual Cb signal (i.e., resCb) using an adder 342. Similarly, the reconstructed Cr signal is formed by combining the filtered-predicted Cr 350 and residual Cr signal (i.e., resCr) using an adder 352.

### Chroma DM Mode

For Chroma DM mode, the intra prediction mode of the corresponding (collocated) luma block covering the centre position of the current chroma block is directly inherited.

### Decoder Side Intra Mode Derivation (DIMD)

To implicitly derive the intra prediction modes of a block, a texture gradient analysis is performed at both encoder and decoder sides. This process starts with an empty Histogram of Gradient (HoG) with 65 entries, corresponding to the 65 angular modes. Amplitudes of these entries are determined during the texture gradient analysis.

### Template-based Intra Mode Derivation (TIMD)

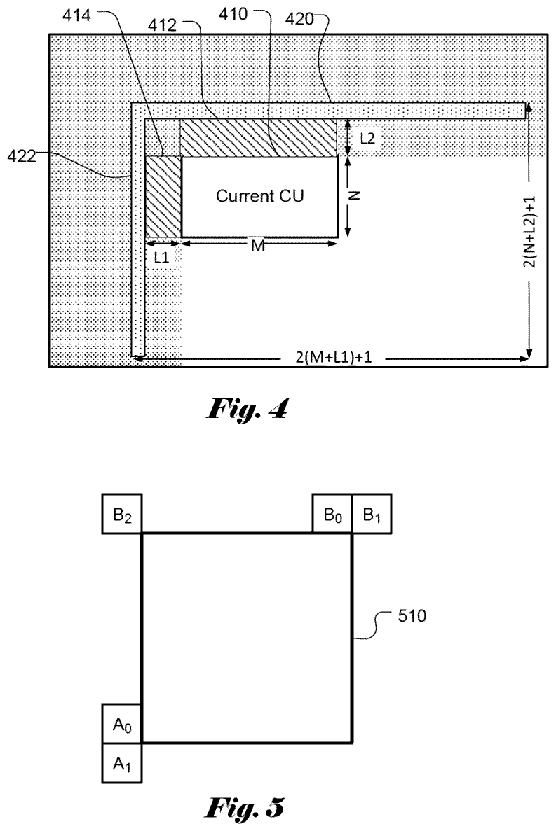

Template-based Intra Mode Derivation (TIMD) mode implicitly derives the intra prediction mode of a CU by using a neighbouring template at both the encoder and decoder, instead of signalling exact intra prediction mode bits to the decoder. As shown in FIG. 4, the prediction samples of the template are generated using the reference samples of the template for each candidate mode. A cost is calculated as the SATD between the prediction and the reconstruction samples of the template. The intra prediction mode with the minimum cost is selected as the TIMD mode and used for intra prediction of the CU. The candidate modes may be 67 intra prediction modes as in VVC or extended to 131 intra prediction modes. In general, MPMs can provide a clue to indicate the directional information of a CU. Thus, to reduce the intra mode search space and utilize the characteristics of a CU, the intra prediction mode is implicitly derived from MPM list. As shown in FIG. 4, the prediction samples of the template (412 and 414) for the current block 410 are generated using the reference samples (420 and 422) of the template for each candidate mode.

### Intra Template Matching

Intra template matching prediction (IntraTMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.

### Inter Prediction Overview

For each inter-predicted CU, motion parameters consisting of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU, not only for skip mode. The alternative to merge mode is the explicit transmission of motion parameters, where motion vector, corresponding reference picture index for each reference picture list and reference picture list usage flag and other needed information are signalled explicitly per each CU.

Beyond the inter coding features in HEVC. VVC includes a number of new and refined inter prediction coding tools listed as follows:
Extended merge prediction
Merge mode with MVID (MMVD)
Symmetric MVD (SMVD) signalling
Affine motion compensated prediction
Subblock-based temporal motion vector prediction (SbTMVP)
Adaptive motion vector resolution (AMVR)
Motion field storage: 1/16^{th} luma sample MV storage and 8×8 motion field compression
Bi-prediction with CU-level weight (BCW)
Bi-directional optical flow (BDOF)
Decoder side motion vector refinement (DMVR)
Geometric partitioning mode (GPM)
Combined inter and intra prediction (CIIP)

### Extended Merge Prediction

In VVC, the merge candidate list is constructed by including the following five types of candidates in order:
1) Spatial MVP from spatial neighbour CUs
2) Temporal MVP from collocated CUs
3) History-based MVP from a FIFO table
4) Pairwise average MVP
5) Zero MVs.

### Spatial Candidate Derivation

The derivation of spatial merge candidates in VVC is the same as that in HEVC except that the positions of first two merge candidates are swapped. A maximum of four merge candidates (B₀, A₀, B₁ and A₁) for curent CU 510 are selected among candidates located in the positions depicted in FIG. 5. The order of derivation is B₀, A₀, B₁, A₁ and B₂. Position B₂ is considered only when one or more neighbouring CU of positions B₀, A₀, B₁, A₁ are not available (e.g. belonging to another slice or tile) or is intra coded. After candidate at position A₀ is added, the addition of the remaining candidates is subject to a redundancy check which ensures that candidates with the same motion information are excluded from the list so that coding efficiency is improved.

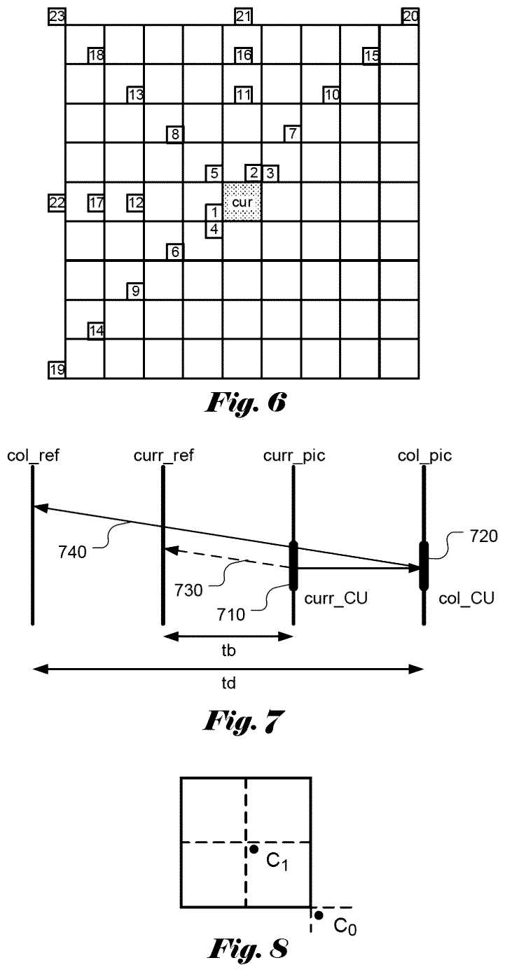

In addition to the above-mentioned spatial candidates, the non-adjacent spatial merge candidates as in JVET-L0399 (Yu Han, et al., “CE4.4.6: Improvement on Merge/Skip mode”. Joint Video Exploration Team (JVET) of 1TU-T SG 16 WP 3 and ISO/IEC JTC 1/SC 29/WG 11, 12th Meeting: Macao, CN, 3-12 Oct. 2018, Document: JVET-L0399) are inserted after the TMVP in the regular merge candidate list. The pattern of spatial merge candidates is shown in FIG. 6. The distances between non-adjacent spatial candidates and current coding block are based on the width and height of current coding block. The line buffer restriction is not applied.

### Temporal Candidates Derivation

In this step, only one candidate is added to the list. Particularly, in the derivation of this temporal merge candidate for a current CU 710, a scaled motion vector is derived based on the co-located CU 720 belonging to the collocated reference picture as shown in FIG. 7. The reference picture list and the reference index to be used for the derivation of the co-located CU is explicitly signalled in the slice header. The scaled motion vector 730 for the temporal merge candidate is obtained as illustrated by the dotted line in FIG. 7, which is scaled from the motion vector 740 of the co-located CU using the POC (Picture Order Count) distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

The position for the temporal candidate is selected between candidates C₀ and C₁, as depicted in FIG. 8. If CU at position C₀ is not available, is intra coded, or is outside of the current row of CTUs, position C₁ is used. Otherwise, position C₀ is used in the derivation of the temporal merge candidate.

### History-Based Merge Candidates Derivation

The history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

### Pair-Wise Average Merge Candidates Derivation

Pairwise average candidates are generated by averaging predefined pairs of candidates in the existing merge candidate list, using the first two merge candidates. The first merge candidate is defined as p0Cand and the second merge candidate is defined as plCand, respectively. The averaged motion vectors are calculated according to the availability of the motion vector of p0Cand and p1 Cand separately for each reference list. If both motion vectors are available in one list, these two motion vectors are averaged even when they point to different reference pictures, and its reference picture is set to the one of p0Cand; if only one motion vector is available, use the one directly; if no motion vector is available, keep this list invalid. Also, if the half-pel interpolation filter indices of p0Cand and p1Cand are different, it is set to 0.

When the merge list is not fill after pair-wise average merge candidates are added, the zero MVPs are inserted in the end until the maximum merge candidate number is encountered.

### Merge Estimation Region

Merge Estimation Region (MER) allows independent derivation of merge candidate list for the CUs in the same merge estimation region (MER). A candidate block that is within the same MER as the current CU is not included for the generation of the merge candidate list of the current CU. In addition, the updating process for the history-based motion vector predictor candidate list is updated only if (xCb+cbWidth)>>Log 2ParMrgLevel is greater than xCb>>Log 2ParMrgLevel and (yCb+cbHeight)>>Log 2ParMrgLevel is great than (yCb>>Log 2ParMrgLevel) and where (xCb, yCb) is the top-left luma sample position of the current CU in the picture and (cbWidth, cbHeight) is the CU size. The MER size is selected at encoder side and signalled as log 2_parallel_merge_level_minus2 in the sequence parameter set.

In order to improve the coding performance of cross-component prediction, various schemes are disclosed.

The cross-component information is used to improve prediction accuracy of an inter block. To improve the prediction accuracy of the chroma component of the inter block, the luma information from the corresponding luma component and/or the chroma information from the previous coded (i.e., encoded or decoded) chroma component are used.
The first scheme is that for a coding unit (under single tree splitting) including luma (Y) and chroma (Cb and/or Cr) components, the prediction for Cb and/or Cr is improved by using the information from Y.
The second scheme is that for a coding unit (under single tree splitting) including luma (Y) and chroma (Cb and/or Cr) components or for a coding unit (under chroma dual tree splitting) including chroma (Cb and/or Cr) components, the prediction for Cr is improved by using the information from Cb. For example, deriving model parameters by using neighbouring reconstructed samples of Cb and Cr as the inputs X and Y of model derivation. Then generating Cr prediction by the derived model parameters and Cb reconstructed samples.

In the following, several embodiments related to the first scheme are proposed to use an inherited cross-component mode for the current chroma block by a) building a candidate list for the current block where the candidate list includes cross-component models, b) selecting one or more model information in the list, and c) using the model information (similar to intra chroma cross-component mode) to generate one or more hypotheses of predictions for the current chroma component (Cb or Cr) by applying and/or modifying the selected model information to the reconstructed or predicted samples for the corresponding luma component. When the selected model information refers to traditional cross-component linear model(s), the proposed method is called as inter cross-component linear model (inter CCLM) mode. When the selected model information refers to convolutional cross-component model(s) derived by a regression-based method (as CCCM for example), the proposed method is called as inter cross-component convolution model (inter CCCM) mode. Moreover, in some embodiments, a self-derived (re-derived) cross-component mode is proposed and can be added into the candidate list in step a) “building a candidate list for the current block where the candidate list includes cross-component models”. In some embodiments, the selection of using the proposed inherited mode and/or using the proposed self-derived mode is determined following an explicit rule, an implicit rule, or both. More details are described in the section entitled “IV. Selection of Using the Proposed Inherited Mode and/or Self-Derived Mode”.

In one embodiment, the proposed embodiments can also be used for the second scheme by using the previous coded chroma component (Cb) as the luma component in the first scheme.

### Storage of the Model for the Current Block

In another embodiment, when the current inter block uses the model parameters from the self-derived cross-component mode, the used model parameters can be saved and/or reference by the following coding blocks.

In another embodiment, when the current inter block uses the inherited cross-component mode, the used model parameters can be saved and/or reference by the following coding blocks.

### I. Building a Candidate List Including Cross-Component Models

In one embodiment, when building the merge-like candidate model list (modelList), one or more of the following candidate model information are included.
Spatial model information from spatial neighbour blocks (corresponding to “Spatial MVP from spatial neighbour CUs” for inter)
Temporal model information from collocated blocks (corresponding to “Temporal MVP from collocated CUs” for inter)
History-based model information from a FIFO table (corresponding to “History-based MVP from a FIFO table” for inter)
Pairwise average model information (corresponding to “Pairwise average MVP” for inter)
Default model information (corresponding to “Zero MVs” for inter)

In one sub-embodiment of the candidate type being “Spatial model information from spatial neighbour blocks”, a valid spatial neighbouring block(s) can be from one of spatial adjacent and non-adjacent neighbours (or any subset of the blocks in a neighbouring search region for the current block) which satisfies a pre-defined condition. For example, the pre-defined condition is that the neighbour is coded by a cross-component mode (such as CCLM, MMLM, CCCM, GLM, the mode with mode information inherited from a merge-like candidate list, MH CCLM, and/or any cross-component mode with syntax not belonging to tradition intra prediction modes) or a mode combining with a cross-component modes (such as chroma fusion (or named LM assisted Angular/Planar Mode), inter CCLM, inter CCCM, and/or any traditional mode with syntax not belonging to cross-component modes but using the cross-component information to generate the prediction). When scanning the spatial neighbouring blocks, a candidate is added into the list if the candidate is valid. The following show some scanning orders when adding the Spatial model information from spatial neighbour blocks into the list.
For example, as in FIG. 5, the scanning order follows B₀(above)→A₀ (left)→B1 (right-above)→A₁ (left-bottom)→B₂ (left-above) or any pre-defined order.
For example, in the scanning order, adjacent candidates are prior to or after the non-adjacent candidates.

In another sub-embodiment of the candidate type being “Temporal model information from collocated blocks” the collocated block is from the block in the reference picture as inter mode. For example, when the current block is coded by inter prediction mode, the collocated block is referred by the motion information (including the motion vectors and the reference picture) of the current block. If the current block is a subblock motion mode (e.g. affine mode), each subblock in the current block has its own collocated temporal model information and/or all or any subset of collocated temporal model information referred by the different subblock motions are added into the list. For another example, the temporal model information can be from the collocated block referred by the motion information of the neighbouring blocks for the current block. If the proposed methods are applied to an IBC block or any mode using block vectors, block vector information is used as motion vector where the block vector information is determined by signalling and/or template matching in a pre-defined searching range and/or any implicit or explicit pre-defined rules.

In another sub-embodiment of the candidate type being “History-based model information”, a history-based table (the FIFO table) is built and stores the model information from the previous coded blocks. The table can be reset at the beginning and/or end of a CTU, slice, picture, tile, and/or sequence. One or more history-based candidates can be added into the candidate list by the order from the head to tail of the table or from the tail to head of the table.

In another sub-embodiment of the candidate type being “Pairwise average model information”, the model information of this candidate is derived based on the model information from more than one of the previous candidates in the list. For example, it can average and/or modify the model parameters of more than one candidate as the to-be-applied model parameters. For another example, it can combine more than one prediction as the final prediction, where each of more than one prediction is generated by applying one of models in the candidate list.

In another sub-embodiment, the default model information is added if the list is not full after inserting all pre-defined candidates. Some examples of the default CCLM model information are shown below:
For example, the default alpha (or named as α, a, or scaling parameters) are {0, ⅛, −⅛, 2/8, − 2/8, ⅜, −⅜, . . . }, and the beta (or named as β, b, or offset parameter) is based on the selected default alpha, average neighbouring reconstructed luma sample value, and average neighbouring reconstructed chroma (Cb/Cr) sample value.

In another embodiment, when building modelList, one or more self-derived cross-component candidates are included. In one sub-embodiment, an example of the self-derived cross-component candidate is CCRM. The cross-component prediction (containing target predicted samples) of the current bock is formed by combining one or more proposed source terms and the models (referring to a proposed weighting setting). As shown in Equation (3), pred(i, j) is a target (predicted) sample in the current block which can be obtained after our proposed mechanism, sourceTermSet0 includes one or more source terms from luma component, sourceTermSet1 includes one or more source terms from chroma components, and biasTermSet includes one or more bias terms.

Equation (3) is just an example and our proposed mechanism can use any subset or extension of sourceTermSet0, sourceTermSet1, and biasTermSet. Each sample or any subset of samples in the current block gets its target (predicted) sample according to Equation (3):

pred(i,j)=(sourceTermSet0(i,j)+sourceTermSet1(i,j)+ . . . +biasTermSet) (3)
with the proposed weighting setting, where (i, j) is a sample position in the current block. The content of sourceTermSet0 is described in Section I.1, the content of sourceTermSet1 is described in Section I.2, the content of biasTermSet is described in Section I.3, and the predictor derivation using the proposed source terms and the proposed weighting setting is described in Section I.4. Several examples with our proposed mechanism are shown in Section I.4.
   I.1. Content of sourceTermSet0(i, j)

SourceTermSet0(i, j) includes one or more luma source terms denoted as sourceTerm00, sourceTerm01, . . . , and/or sourceTerm0n-1. The value of n means the number of taps for the source term set. In one embodiment, the source terms can be linear terms and/or non-linear terms, only linear terms, and/or only non-linear terms. In another embodiment, the pattern of the n taps refers to a pattern defined as any subset of a window region M×N around/including the position (iL, jL). If the target sample is chroma (e.g., Cb or Cr). (iL, jL) is the collocated luma position from (i, j).

For a source term in the source term set, the following embodiments are used to determine generation of source content.

In one embodiment, the source content is based on a predicted sample generated by a prediction mode and/or a reconstructed sample generated based on the predicted sample by a prediction mode and a reconstructed residual.

In another sub-embodiment, the source content is the filtered source or the source with any pre-processing. For example, the source content is the predicted/reconstructed sample after filtering with a pre-defined model or filter.

In another sub-embodiment, the source content is gradient information from the predicted samples and/or reconstructed samples.

In another sub-embodiment, since the target sample belongs to a chroma sample (e.g., Cb or Cr)), the predicted sample and/or the reconstructed sample is located within the collocated (luma) block from the current (chroma) block. The predicted sample and/or the reconstructed sample is treated as an initial sample and used as source content to generate the target sample.

In another embodiment, the values of the source terms are further adjusted (e.g. added or subtracted) by a pre-defined offset.

In another embodiment, the source term may further include location information.

I.2. Content of sourceTermSet1(i, j)

SourceTermSet1(i, j) includes one or more chroma (Cb or Cr) source terms denoted as sourceTerm0₀, sourceTerm0₁, . . . , and/or sourceTerm0ₘ₋₁. The value of m means the number of taps for the source term set. In one embodiment, the source terms can be linear terms and/or non-linear terms, only linear terms, and/or only non-linear terms. In another embodiment, the pattern of the m taps refers to a pattern defined as any subset of a window region M2×N2 around/including the position (i_{C}, j_{C}). If the target sample is chroma (Cb or Cr), (i_{C}, j_{C}) is (i, j).

For a source term in the source term set, the following embodiments are used to determine generation of source content.

In one embodiment, the source content is based on a predicted sample generated by a prediction mode and/or a reconstructed sample generated based on the predicted sample by a prediction mode and a reconstructed residual.

In another sub-embodiment, the source content is the filtered source or the source with any pre-processing. For example, the source content is the predicted/reconstructed sample after filtering with a pre-defined model or filter.

In another sub-embodiment, the source content is gradient information from the predicted samples and/or reconstructed samples.

In another sub-embodiment, if the target sample belongs to a chroma sample, the predicted sample and/or the reconstructed sample is located within the current block. The predicted sample and/or the reconstructed sample is treated as an initial sample and used as source content to generate the target sample.

In another embodiment, the values of the source terms are further adjusted (e.g., added or subtracted) by a pre-defined offset.

In another embodiment, the source term may further include location information. For example, if the target sample refers to chroma, the horizontal location (i) of (i, j) is used in a source term and the vertical location (j) of (i, j) is used in a source term.

I.3. Content of biasTermSet

Bias term is a pre-defined value. In one embodiment, the bias term is a midValue according to bitDepth specified in the standard. For example, the bias term is set as (1<<(bitDepth-1)). In another embodiment, the bias term is the same for each sample in the current block. That is, the bias term is regardless of the position (i, j).

### I.4. Predictor Derivation for Sample (i, j)

### I.4.1. Proposed Weighting Setting

The proposed weighting setting is to estimate the relationship (minimize the distortion) between “the predicted and/or reconstructed samples on the reference region of the current (chroma) block” and “the predicted and/or reconstructed samples on the reference region of the corresponding luma block” by a pre-defined regression method, and to generate a weighting (referring to model parameters) according to the regression method. The weighting of the source terms derived is then applied to get the target (predicted) samples in the current block. In one embodiment, the pre-defined regression method can be Linear Minimum Mean Square Error (LMMSE) method for CCLM or can be any unified method with the regression method used for CCLM. In another embodiment, the pre-defined regression method can be the LDL decomposition method for CCCM or can be any unified method with the regression method used for CCCM. In another embodiment, the pre-defined regression method can be Gaussian elimination.

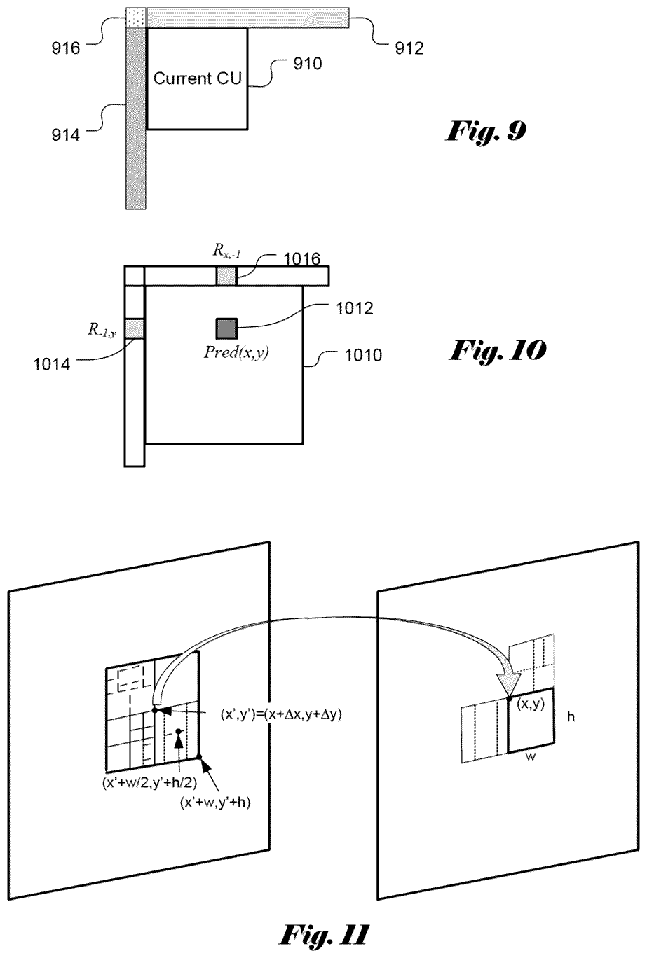

In one embodiment, the reference region of the current block is the spatial neighbouring region of the current block. The spatial neighbouring region of the current block 910 includes above reference region 912, left reference region 914, above-left reference region 916, and/or any subset of the above as shown in FIG. 9.

The reference region of the corresponding luma block is the spatial neighbouring region of the corresponding luma block.

In another embodiment, the reference region of the current block is the vector-collocated region of the current block, where the reference region of the corresponding luma block is the vector-collocated region of the corresponding luma block. For inter coding unit containing luma and chroma blocks, the vector-collocated region of the current block refers to the motion compensated results obtained by using the motion information (motion vectors and reference pictures) of the current block, and the vector-collocated region of the corresponding luma block refers to the motion compensated results obtained by using the motion information(motion vectors and reference pictures) of the corresponding luma block. For IBC or intraTMP, the vector-collocated region of the current block refers to the motion compensated results obtained by using the motion information (block vectors and current picture) of the current block, and the vector-collocated region of the corresponding luma block refers to the motion compensated results obtained by using the motion information (block vectors and current picture) of the corresponding luma block.

In another embodiment, the above-proposed two kinds of the reference region of the current block can be used together. For example, generally, samples in the vector-collocated region of the current block are used as input samples when deriving model parameters; however, for a smaller block, samples in the spatial neighbouring reference region are used as additional input samples when deriving model parameters.

In another embodiment, more details of construction of the modelList can be found in Section VI.

### II. Signalling for Model Information Control

When not applying the proposed inter CCLM (or inter CCCM), the prediction of current block is from the original inter prediction.

In another embodiment, whether to apply inter CCLM (or inter CCCM) or not depends on signalling.

In one sub-embodiment, the signalling refers to a coded TU/TB/CU/CB level flag. The flag may or may not depend on context to code. Take the TU/TB flag as an example, the flag is signalled only if the TU/TB's luma Cbf is non-zero and the enabling flag for the inter mode is true. Take the CU/CB flag as an example, the flag is signalled only if the CU/CB's luma Cbf is non-zero and the enabling flag for the inter mode is true. The enabling flag for the inter mode means the CU's predMode is MODE_INTER when the proposed inter CCLM (or inter CCCM) is supported for all inter modes. When the proposed inter CCLM (or inter CCCM) is supported for IBC. The enabling flag for IBC is checked first and the signalling for inter CCLM (or inter CCCM) is coded/decoded in response to the CU's predMode being MODE_IBC.

In another sub-embodiment, a flag is signalled in the bitstream to indicate whether to apply inter CCLM (or inter CCCM) or not. For example, the flag is context coded. For another example, only one context is used when coding the flag. For another example, multiple contexts are used to code the flag and the selection of the contexts depends on block width, block height, block area, or neighbouring mode information.

In another sub-embodiment, when the signaling indicates to apply inter CCLM (or inter CCCM), additional signalling is used to select one or more models from total candidates (e.g. modelList may comprise candidates as describe in Section I, CCLM_LT, CCLM_L, CCLM_T, MMLM_L, MMLM_T, MMLM_L, or any subset/extension from the above mentioned modes). For example, if a target LM mode is selected, the LM prediction is generated by the selected target LM. For another example, if more than one LM mode is selected, the LM prediction is generated by blending hypotheses of predictions from multiple LM modes. For another example, the additional signalling refers to an index in the bitstream that can be truncated unary coding with and/or without contexts.

In another sub-embodiment, when the signalling indicates to apply inter CCLM (or inter CCCM), one or more models from total candidates (e.g. modelList may comprise candidates as describe in Section I, CCLM_LT, CCLM_L, CCLM_T, MMLM_L, MMLM_T, MMLM_L, or any subset/extension from the above mentioned modes) are implicitly selected (or predefined) to be used in inter CCLM (or inter CCCM).
For example, CCLM_LT is used to generate LM prediction for inter CCLM. For example, MMLM_LT is used to generate LM prediction for inter CCLM. Similar rules can be applied to inter CCCM with using convolutional models instead.
For another example of inter CCLM, the predefined nile depends on block width, block height, or block area. Similar rules can be applied to inter CCCM with using convolutional models instead.
   Boundary matching setting (used as the pre-defined rule) can be applied only when the block width, block height, or block area is larger than a threshold.
   Boundary matching setting (used as the predefined rule) can be applied only when the block width, block height, or block area is smaller than a threshold.
   When the block width, block height, or block area is smaller than a threshold, the selected LM mode(s) is(are) inferred as any one (more than one) LM mode(s) from total candidate LM modes.
      The selected LM mode is fixed as CCLM_LT.
      The selected LM mode is fixed as MMLM_LT.

For another example, the predefined rule depends on boundary matching setting.

In another embodiment, inter CCLM (or inter CCCM) can be supported only when the size conditions of the current block are satisfied.

In one sub-embodiment, the size condition is that the block width, block height, or block area is larger than a pre-defined threshold. The predefine threshold can a positive integer such as 8, 16, 32, 64, 128, 256, . . . , etc.

In another sub-enbodiment, the size condition is that the block width, block height, or block area is smaller than a pre-defined threshold. The predefine threshold can a positive integer such as 8, 16, 32, 64, 128, 256, 512, 1024, 2048, 4096, . . . , etc.

In another embodiment, the inter mode used in the inter block depends on an enabling flag. For example, if the inter mode is regular merge, the enabling flag is referred as regular merge flag. For another example, if the inter mode is CIIP, the enabling flag is referred as CIIP flag. For another example, if the inter mode is CIIP PDPC, the enabling flag is referred as CIP PDPC flag. For another example, the enabling flag indicated as enabled (equal to 1) means the corresponding inter mode is applied to the current block. For another example, the enabling flag indicated as disabled (equal to 0) means the corresponding inter mode is not applied to the current block. For another example, the enabling flag is signalled in the bitstream and/or inferred in some cases. For another example, the signalling of the enabling flag depends on block width, block height, or block area.

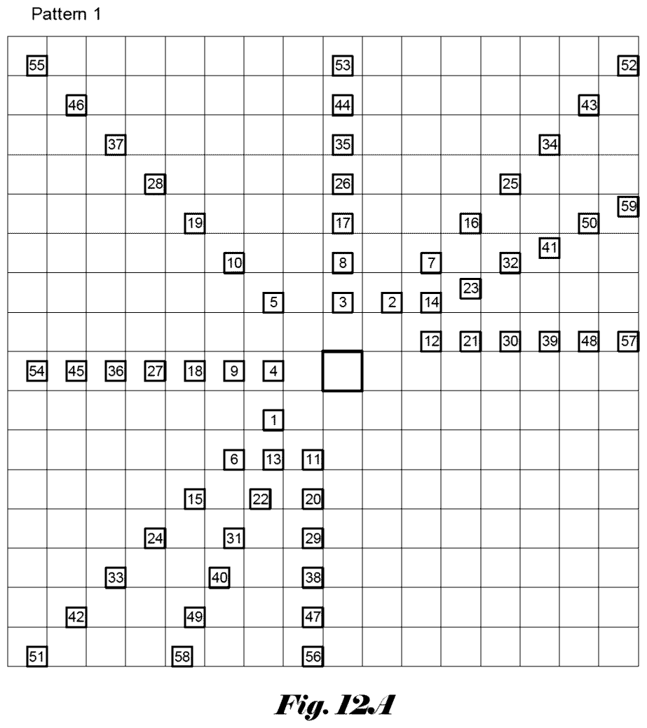

In another embodiment, the prediction from inter can be adjusted by the neighbouring reconstructed samples and a pre-defined weighting scheme. For example, when the current block is merge, the prediction from merge is blended with the neighbouring reconstructed samples. For another example, the proposed scheme is enabled depending on CIIP PDPC flag. (The CUP PDPC flag may be signalled when the CIIP flag is indicated as enabled.) For another example, the pre-defined weighting scheme follows PDPC weighting. FIG. 10 illustrates an example of PDPC for adjusting the predictors of the current block 1010. The horizontal neighbouring reconstructed samples (R−1, y) 1014 and/or vertical neighbouring reconstructed samples (Rx, −1) 1016 are used to adjust the predictor(x, y) 1012.
Inter-predictor of regular merge mode is refined using the above R_{x, -1} and left R_{-1, y} reconstructed samples
Derivation of nScale and wT & wL are the same as in intra planar mode

$$wT = 32 ≫ ( ( y ≪ 1 ) ≫ nScale )$$

$$wL = 32 ≫ ( ( x ≪ 1 ) ≫ nScale )$$

nScale=(floorLog 2(width)+floorLog 2(height)−2)>>2;
CIIP PDPC:
   If LMCS is enabled, inter-predictor is computed in mapped domain

$$Pred ( x , y ) = ( ( ( ( wT \times {R}_{x , - 1} + wL \times {R}_{- 1 , y} + 32 ) ≫ 6 ) ≪ 6 ) + ( 64 - wT - wL ) \times Fwd ( predInter ( x , y ) ) + 32 ) ≫ 6$$

Otherwise, inter-predictor is computed in original domain

$$Pred ( x , y ) = ( ( ( ( wT \times {R}_{x , - 1} + wL \times {R}_{- 1 , y} + 32 ) ≫ 6 ) ≪ 6 ) + ( 64 - wT - wL ) \times predInter ( x , y ) + 32 ) ≫ 6$$

When CIIP flag is true, CP PDPC flag is further signalled to indicate whether to use CIIP PDPC

In another embodiment, original inter prediction (generated by motion compensation) is used for luma and the predictions of chroma components are generated by CCLM and/or any other LM modes.

In one sub-embodiment, the current CU is viewed as an inter CU, intra CU, or a new type of prediction mode (neither intra nor inter).

In another embodiment, the one or more LM mode(s) (or cross-component mode(s)) which will be used to generate the one or more hypotheses of predictions for LM assisted Angular/Planar Mode/inter CCLM/inter CCCM/MH CCLM are selected from a pre-defined merging candidate list (called modelList). One modelIdx is signalled to select a candidate from the candidate list (modelList) and the selected candidate is used for the current block. The modelList contains one or more candidates where each candidate refers to a model (or cross-component mode) information. If only one candidate is in the list (the size of the list is only 1), the modelIdx is not signalled and/or, can be inferred as 0 or a default value.

In one embodiment, when building modelList, one or more predefined candidates are added. The pre-defined candidates can include any subset/extension of the following candidates:
CCLM family: CCLM_LT, CCLM_L, CCLM_T
MMLM family: MMLM_LT, MMLM_L, MMLM_T
CCCM family: CCCM_LT, CCCM_L, CCCM_T

The above proposed methods can be also applied to IBC blocks or the blocks with any IBC sub-modes (e.g. IBC merge or IBC AMVP or any IBC mode under IBC syntax). (“inter” in this invention can be changed to IBC.) That is, for chroma components, the block vector prediction can be combined or replaced with cross-component prediction.

### III. Generating Hypotheses of Predictions

### III.1. Concept

In one embodiment, prediction or reconstruction-based model is used to generate one hypothesis of prediction for the current chroma component.

In one embodiment for a prediction based linear model, the derived model parameters are applied to the predicted samples for the first component (Y) to get the predicted samples for the second or third component:

$$P ( i , j ) = a \cdot {pred}_{L}^{′} ( i , j ) + b .$$

The predicted samples for the first component are downsampled with the downsampling filters (which may be fixed at one-predefined filter or selected among some candidate filters).

In another sub-embodiment of a reconstruction based linear model, the derived model parameters are applied to the reconstructed samples for the first component (Y) to get the predicted samples for the second or third component:

$$P ( i , j ) = a \cdot {reco}_{L}^{′} ( i , j ) + b .$$

The reconstructed samples for the first component are down-sampled with the downsampling filters (which may be fixed at one predefined filter or selected among some candidate filters).

Prediction or reconstruction based convolution model is similar to the proposed methods for the prediction or reconstruction based linear model. The main difference is that the model coefficient pattern follows CCCM (not CCLM) and the luma samples may or may not be down-sampled first. If not applying down-sampling to the luma samples, more taps (model coefficients) may be used to access the non-down-sampled luma samples.

### III.2. CCLM for Inter Block

CCLM for inter block can also be named as inter CCLM and “CCLM” can be extended to any LM mode (or any cross-component mode) or replaced with any LM mode (or any cross-component mode). When convolutional cross-component models derived by a regression-based method is used, CCLM for inter block can also be named as inter CCCM.

In one embodiment, for chroma components, in addition to original inter prediction (generated by motion compensation which can be uni-prediction and/or bi-prediction, multiple hypotheses of prediction from multiple motion candidates which may refer to one or more merge candidates and/or one or more AMVP candidates, and/or any combination of above, or which can be only uni-prediction), one or more hypotheses of predictions (generated by CCLM and/or any other LM modes) are used to output the current prediction.

In one sub-embodiment, the current prediction is the weighted sum of inter prediction and CCLM prediction.

In another embodiment, the inter prediction can be generated by any inter mode mentioned above. For example, the inter mode can be regular merge mode. For another example, the inter mode can be CIIP mode. For another example, the inter mode can be GPM or any GPM variations (e.g., GPM intra referring one prediction unit using intra prediction).

In another embodiment, inter CCLM is supported only when any one (or more than one) of the pre-defined inter mode is used for the current block, or inter CCLM is supported when any one (or more than one) of the enabling flag(s) of the pre-defined inter mode is (are) indicated as enabled. The meaning of supporting inter CCLM is that the prediction of the current block can be chosen between applying inter CCLM or not applying inter CCLM.

For another example, if CCLM mode is used for generating the chroma prediction samples and luma prediction is from an inter coding tool, a flag is used to indicate if the CCLM model used for the chroma prediction is inherited from the CCLM models used in the previous coded blocks or the CCLM model is from a predetermined CCLM mode. If the CCLM model is inherited from the CCLM models used in the previous coded blocks, an index is used to indicate which model in the list is inherited or modified. Otherwise, a predetermined CCLM mode is used to implicitly derive the CCLM model for the current chroma prediction.

IV. Selection of Using the Proposed Inherited Mode and/or Self-Derived Mode

In one embodiment, a flag can be signalled to indicate/select if the re-derived model is used. If the flag is 0, the cross-component model used to encode the neighbour merge candidate is inherited. If the flag is 1, the re-derived method is used.

In another embodiment, an implicit rule (not using the additional flag) is used to determine whether to use the re-derived model.

In another embodiment, when the proposed inherited method is used, the candidate with the smallest cost (e.g. the first candidate in the modelList) is implicitly selected to generate the cross-component prediction. For another example, an index is signalled to select one or more candidates from the modelList. More details can be found in Section II.

### V. Details of Cross-Component Model Information in Candidate List

### V.1. Inheriting CCM Information

In one embodiment, the cross-component model (CCM) information of inherited cross-component model can be stored together with the inherited model parameters. The CCM information can be inherited together with the inherited model parameters. The prediction of the current block can be generated based on the inherited CCM information and inherited model parameters. The CCM information can include but not limited to prediction mode (e.g., CCLM, MMLM, CCCM, 2-parameter GLM, 3-parameter GLM), model index for indicating which model shape is used in convolutional model, classification threshold for multi-model, information to indicate non-downsampled samples are used in convolutional model, down-sampling filter flag, down-sampling filtering index when multiple down-sampling filters are used, number of neighbouring lines used to derive model, types of templates used to derive model, post-filtering flag and model parameters.

In one embodiment, a mixed CCCM model consisting of various terms (e.g., spatial term, gradient term, location term, non-linear term and bias term) can be inherited. In addition to storing model parameters, a prediction mode can be stored in the CCM information to indicate that the inherited model is a mixed CCCM model consisting of various terms. If there are multiple types of mixed CCCM models, a model index can also be stored in the CCM information to indicate which type of mixed CCCM model is inherited. For example, gradient and location based CCCM (GL-CCCM) proposed in JVET-AB0119(Ramin G. Youvalari, et al., “Non-EE2: Gradient and location based convolutional cross-component model (GL-CCCM) for intra prediction”, Joint Video Exploration Team (JVET) of ITU-T SG 16 WP 3 and ISO/IEC JTC 1/SC 29/WG 11, 28th Meeting, Mainz, DE, 20-28 Oct. 2022, Document: JVET-AB0119) is a mixed CCCM model which consists of one spatial term in centre position, two gradient terms for horizontal direction and vertical direction, two location term X and Y for the relative horizontal location and relative vertical location, one non-linear term and one bias term. A prediction mode can be stored in the CCM information to indicate that the inherited model is a GL-CCCM model.

### V.2. Inheriting Spatial Neighbouring Model Parameters

In one embodiment, the inherited model parameters can be from a block that is an immediate neighbouring block. The models from blocks at pre-defined positions are added into the candidate list in a pre-defined order.

In one embodiment, the pre-defined positions and the pre-defined order can be the same as those of spatial candidates for inter merge mode.

In one embodiment, the pre-defined positions can be the positions depicted in FIG. 5. The pre-defined order can be B₀, A₀, B₁, A₁ and B₂ or A₀, B₀, B₁, A₁ and B₂.

In one embodiment, assume the position, width and height of the current block are (x, y), W and H respectively, the pre-defined positions can include positions immediately above the current block, such as (x+W>>1, y−1) or (x+(W+1)>>1, y−1), if W is greater than or equal to a threshold TH. The pre-defined positions can also include positions immediately left to the current block, such as (x−1, y+H>>1) or (x−1, y+(H+1)>>1), if H is greater than or equal to a threshold TH. TH can be 2, 4, 8, 16, 32, or 64.

In one embodiment, there is a maximum number of inherited models from spatial neighbours that can be added into the candidate list, and the maximum number is smaller than the number of pre-defined positions.

For example, if the pre-defined positions are as depicted in FIG. 5, there are 5 pre-defined positions. If pre-defined order is B₀, A₀. B₁, A₁, and B₂, and the maximum number of inherited models from spatial neighbours is 4, the model from B₂ is added to the candidate list only when one of preceding blocks is not available or is not coded in cross-component model.

In one embodiment, the pre-defined positions include the positions at the immediate above (W>>1) or ((W>>1)−1) position if W is greater than or equal to TH, and the positions at the immediate left (H>>1) or ((H>>1)−1) position if H is greater than or equal to TH, where W and H are the width and height of the current block, TH is a threshold value which can be 4, 8, 16, 32, or 64.

### V.3. Inheriting Temporal Neighbouring Model Parameters

In one embodiment, if the current slice/picture is a non-intra slice/picture, the inherited model parameters can be from the block in the previous coded slices/pictures.

In one embodiment, the current block position is at (x, y) and the block size is w×h. The inherited model parameters can be from the block at some pre-defined positions of the previous coded slices/picture.

In one sub-embodiment, the pre-defined positions can be (x+Δx, y+Δy) or (x_{mid}+Δx,y_{mid}+Δy), where

$$( {x}_{mid} , {y}_{mid} ) = ( x + \frac{w}{2} , y + \frac{h}{2} ) .$$

The two value sets αₓ and α_{y} are defined as:

$${α}_{x} = \{ {α}_{x 1} , {α}_{x 2} , {α}_{x 3} , ... , {α}_{xn} \} , {α}_{xi} < {α}_{xj} if i < j ,$$

$${α}_{y} = \{ {α}_{y 1} , {α}_{y 2} , {α}_{y 3} , ... , {α}_{yn} \} , {α}_{yi} < {α}_{yj} if i < j .$$

All values in αₓ and α_{y} are positive numbers.

For example, (Δx, Δy) can be (±αₓᵢ×w, ±α_{yi}×h), (±αₓᵢ×w, 0), (0, ±α_{yi}×h).

For another example, (Δx, Δy) can be (±αₓᵢ×δx, ±α_{yi}×δy), (±αₓᵢ×δx, 0), (0, ±α_{yi}×δγ), where δx and δy are two fixed positive numbers.

For yet another example, αₓ=α_{y}, such as αₓ=α_{y}={1,2,3,4,5}.

For yet another example, αₓ≠α_{y}, such as αₓ={½,1, 3/2, 2, 5/2} and α_{y}={1, 2, 3, 4,5}.

In one sub-embodiment, the pre-defined positions (x′, y′) are inside the corresponding area of the current encoding block. i.e., x≤x′<x+w and y≤y′<y+h. The pre-defined positions can be (x, y), (x+w−1, y), (x, y+h−1), (x+w−1, y+h−1), (x+w/2,y+h/2), (x,y+h/2), (x+w/2,y).

In one sub-embodiment, the pre-defined positions (x′, y′) are outside of the corresponding area of the current encoding block, i.e., x′<x+ or x′≥x+w, and y′<y or y′≥y+h. The pre−defined positions can be (x−1, y), (x, y−1), (x−1, y−1), (x+w, y), (x+w−1, y−1), (x+w, y−1), (x, y+h), (x−1, y+h−1), (x−1, y+h), (x+w, y+h−1), (x+w−1, y+h), (x+w, y+h).

In one embodiment, the models from the positions closer to (x, y) are added into the final merge candidate list first.

The previous coded picture, from which the inherited parameter model is obtained, is referred to as the collocated picture hereafter.

In one embodiment, the previous coded picture where the inherited parameter model is from, i.e., the collocated picture, is one of the pictures in the reference lists.

The two value sets αₓ and α_{y} are defined as:

$${α}_{x} = \{ {α}_{x 1} , {α}_{x 2} , {α}_{x 3} , ... , {α}_{xn} \} , {α}_{xi} < {α}_{xj} if i < j$$

$${α}_{y} = \{ {α}_{y 1} , {α}_{y 2} , {α}_{y 3} , ... , {α}_{yn} \} , {α}_{yi} < {α}_{yj} if i < j .$$

All values in αₓ and α_{y} are positive numbers. The inherited model parameters can be from the block at positions (x′+αₓᵢ×w, y′+α_{yi}×h), (x′+αₓᵢ×w, y′−α_{yi}×h), (x′−αₓᵢ×w, y′+α_{yi}×h), (x′−αₓᵢ×w, y′−α_{yi}×h), (x′+αₓᵢ×w, y′), (x′−αₓᵢ×w,y′), (x′,y′+α_{yi}×h), (x′,y′−α_{yi}×h) of the previous coded slices/picture. For another example, let δx and δy be two fixed positive numbers. The inherited model parameters can be from the block at positions (x′+αₓᵢ×δx, y′+α_{yi}×δy), (x′+αₓᵢ×δx, y′−α_{yi}×δy), (x′−αₓᵢ×δx, y′+α_{yi}×δy), (x′−αₓᵢ×δx, y′−α_{yi}×δy), (x′+αₓᵢ×δx,y′), (x′−αₓᵢ×δx,y′), (x′, y′+α_{yi}×δy), (x′y′−α_{yi}×δy) of the previous coded slices/picture. For another example, the inherited model parameters can be from the block at some pre-defined positions relative to (x′, y′) of the previous coded slices/picture. The positions can be (x′, y′), (x′+w−1, y), (x′, y′+h−1), (x′+w−1, y′+h−1),

$$( {x}^{′} + \frac{w}{2} , {y}^{′} + \frac{h}{2} ) .$$

For another example, the positions can be (x′−1, y′), (x′, y′−1), (x′−1, y′−1), (x′+w, y′), (x′+w−1, y′−1), (x′+w, y′−1), (x′, y′+h), (x′−1, y′+h−1), (x′−1, y′+h), (x′+w, y′+h−1), (x′+w−1, y′+h), (x′+w, y′+h).

In one embodiment, as shown in FIG. 11, the current block position is at (x, y) and the block size is w×h. The inherited model parameters can be from the block at position (x′, y′), (x′, y′+h/2), (x′+w/2, y′), (x′+w/2, y′+h/2), (x′+w, y′), (x′, y′+h), or (x′+w, y′+h) of the previous coded slices/picture, where x′=x+Δx and y′=y+Δy.

In one sub-embodiment, if the prediction mode of the current block is inter, Δx and Δy are set to the horizontal and vertical motion vector of the current block.

In another sub-embodiment, if the current block is inter bi-prediction, Δx and Δy are set to the horizontal and vertical motion vector in reference picture list 0.

In another sub-embodiment, if the current block is inter bi-prediction, Δx and Δy are set to the horizontal and vertical motion vector in reference picture list 1.

### V.4. Inheriting Non-Adjacent Spatial Neighbouring Models

In one embodiment, the inherited model parameters can be from blocks that are non-adjacent spatial neighbouring blocks. The models from blocks at pre-defined positions are added into the candidate list in a pre-defined order.

In one sub-embodiment, the pre-defined positions and the pre-defined order are the same as those of non-adjacent spatial neighbouring candidates for inter merge mode. For example, the pattern of the positions and order can be the same as the pattern depicted in FIG. 6, where the distance between each position is the width and height of current coding block.

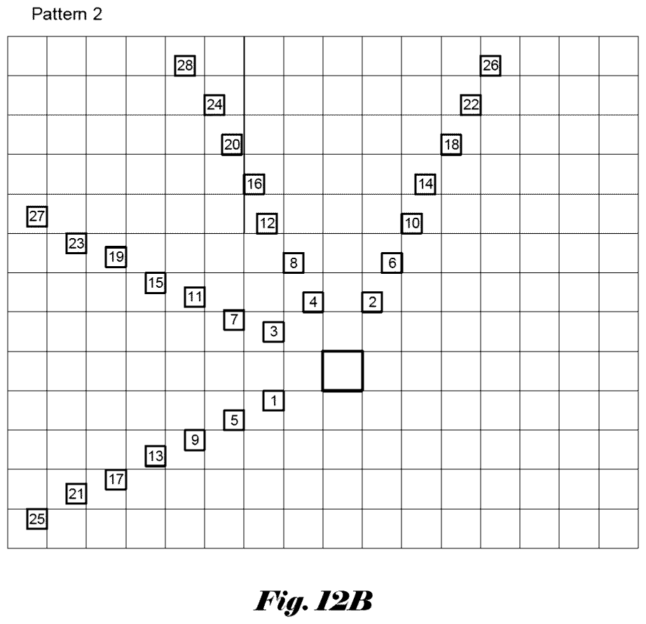

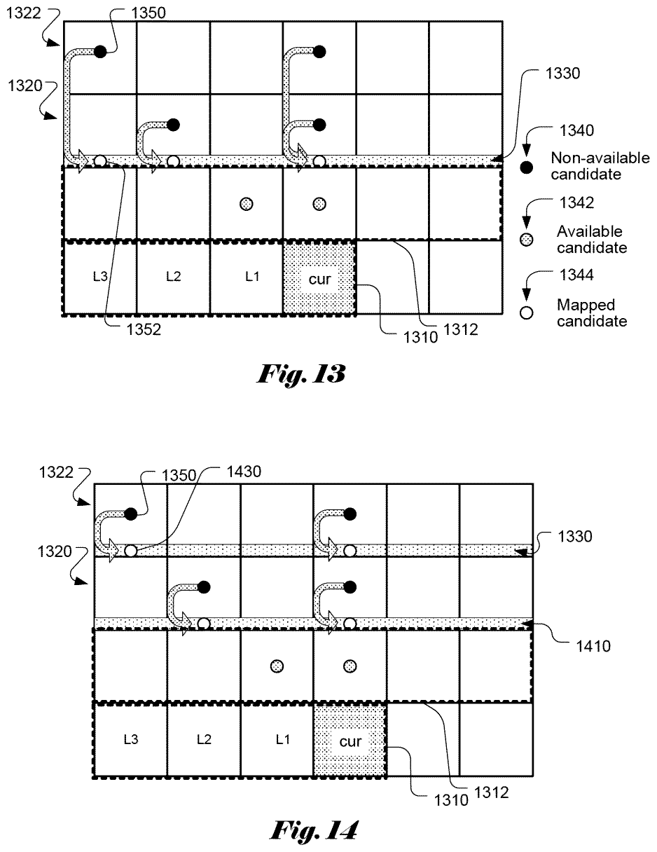

In one sub-embodiment, the pre-defined positions and the pre-defined order are as depicted in FIG. 12A and FIG. 12B. The positions of the numbered squares are the pre-defined positions. The number inside each square indicate the pre-defined order. Positions in Pattern 1 is added into the list before positions in Pattern 2. The distance between each pre-defined positions are proportional to the width and height of the current block.

In one embodiment, the distance between the positions that are closer to the current encoding block is smaller than the positions that are further away from the current block. In another embodiment, the distance between the positions that are closer to the current encoding block is larger than the positions that are further away from the current block

In one embodiment, there is a maximum number of inherited models from non-adjacent spatial neighbours that can be added into the candidate list, and the maximum number is smaller than the number of pre-defined positions. For example, if the pre-defined positions are as depicted in FIGS. 12A-B, where there are 2 search patterns. The positions in Pattern 1 are included in the candidate list before the positions in Pattern 2. If the maximum number of inherited models from non-adjacent spatial neighbours is N, the search pattern 2 is used only when the number of available models from search pattern 1 is smaller than N.

V.5. Inheriting Model Parameters from History Table

In one embodiment, the inherited model parameters can be from a cross-component model history table. The history table stores CCM information of valid previous coded blocks. The valid previous coded block refers to any blocks containing valid CCM information. The cross-component models in the history table can be added into the candidate list according to a pre-defined order. In one embodiment, the adding order of historical candidate can be from the beginning of the table to the end of the table. In another embodiment, the adding order of historical candidate can be from the end of the table to the beginning of the table.

In one embodiment, one cross-component model history table can be maintained for storing the previous cross-component model (i.e., CCM information), and the cross-component model history table can be reset at the start of the current picture, current slice, current tile, every M CTU rows or every N CTUs, N and M can be any value greater than 0. In another embodiment, the cross-component model history table can be reset at the end of the current picture, current slice, current tile, current CTU row or current CTU.

In another embodiment, multiple history table are used for storing different type of cross-component model. For example, the first history table is used for storing single model, and the second history table is used for storing multi-model. For another example, the first history table is used for storing gradient model, and the second history table is used for storing non-gradient model. For another example, the first history table is used for storing simple linear model (e.g., y=αₓ+b), and the second history table is used for storing complicated model (e.g., CCCM).

In one embodiment, when adding historical candidates from multiple history tables to the candidate list, the adding order can be from the beginning of to the end of a certain table, and then the next history table is added in the same order or in a reversed order.

In one embodiment, let the current block position be (x, y) and the block size be w×h. The two value sets αₓ and α_{y} are defined as:

$${α}_{x} = \{ {α}_{x 1} , {α}_{x 2} , {α}_{x 3} , ... , {α}_{xn} \} , {α}_{xi} < {α}_{xj} if i < j$$

$${α}_{y} = \{ {α}_{y 1} , {α}_{y 2} , {α}_{y 3} , ... , {α}_{yn} \} , {α}_{yi} < {α}_{yj} if i < j .$$

All values in aₓ and ay are positive numbers. Let x′=x+Δx and y′=y+Δy. The inherited model parameters can be from the positions determined by x′ and y′. For example, the inherited model parameters can be from the block at positions (x′+αₓᵢ×w, y′+α_{yi}×h), (x′+αₓᵢ×w, y′−α_{yi}×h), (x′−αₓᵢ×w, y′+α_{yi}×h), (x′−αₓᵢ×w, y′−α_{yi}×h), (x′+αₓᵢ×w, y′), (x′−αₓᵢ×w, y′), (x′,y′+α_{yi}×h), (x′,y′−α_{yi}×h). For another example, let δx and δy be two fixed positive numbers. The inherited model parameters can be from the block at positions (x′+αₓᵢ×δx, y′+α_{yi}×δy), (x′+αₓᵢ×δx, y′−α_{yi}×δy), (x′−αₓᵢ×δx, y′+α_{yi}×δy), (x′−αₓᵢ×δx, y′−α_{yi}×δy), (x′+αₓᵢ×δx,y′), (x′−αₓᵢ×δx,y′), (x′, y′+α_{yi}×δy), (x′, y′−α_{yi}×δy). For another example, the inherited model parameters can be from the block at some pre-defined positions relative to (x′, y′) of the previous coded slices/picture. The positions can be (x′, y′), (x′+w−1, y′), (x′, y′+h−1), (x′+w−1, y′+h−1),

$$( {x}^{′} + \frac{w}{2} , {y}^{′} + \frac{h}{2} ) .$$

For another example, the positions can be (x′−1, y′), (x′, y′−1), (x′−1, y′−1), (x′+w, y′), (x′+w−1, y′−1), (x′+w, y′−1), (x′, y′+h), (x′−1, y′+h−1), (x′−1, y′+h), (x′+w, y′+h−1), (x′+w−1, y′+h), (x′+w, y′+h). For another example, the position can be (x′, y′), (x′, y′+h/2), (x′+w/2, y′). (x′+w/2, y′+h/2), (x′+w, y′), (x′, y′+h), or (x′+w, y′+h).

In one sub-embodiment, if the prediction mode of the current block is IBC, Δx and Δy can be set according to the horizontal and vertical block vector of the current block. For example, Δx and Δy can be equal to the horizontal and vertical block vector of the current block.

In another sub-embodiment, Δx and Δy can be set according to the horizontal and vertical block vector of a neighbouring block. For example, Δx and Δy can be equal to the horizontal and vertical block vector of a neighbouring block.

### V.6. The Available Region of Non-Adjacent Spatial Candidates

To limit the requirement buffer/storage resource, the available range for including non-adjacent spatial candidates should be constrained. In one embodiment, only the cross-component model (CCM) information in the current CTU can be referenced by the non-adjacent spatial candidate. In another embodiment, only the CCM information in the current CTU or left M CTUs can be referenced by the non-adjacent spatial candidate. M can be any integer larger than 0. In another embodiment, only the CCM information in the current CTU row can be referenced by the non-adjacent spatial candidate. In another embodiment, only the to-be referenced position within the current CTU row or above N CTU rows can be referenced. N can be any integer larger than 0. If N is 0, this available region becomes the current CTU row only. Note, the CCM information mentioned in this disclosure includes but not limited to prediction mode (e.g., CCLM, MMLM, CCCM), GLM pattern index, model parameters, or classification threshold.

In another embodiment, the CCM information in the current CTU, the current CTU row, the current CTU row+above N CTU rows, the current CTU+left M CTUs, or the current CTU+above N CTU rows+left M CTUs can be referenced without limits (i.e., unconstrained). Furthermore, the CCM information in other regions can only be referenced by a larger pre-defined unit. For example, the CCM information in the current CTU row is stored within a 4×4 grid, and for other CCM infornation outside the current CTU row is stored within a 16×16 grid. In other words, one 16×16 region only needs to store one CCM information, so the to-be referenced position shall be rounded to the 16×16 grid, or changed to the nearest position of 16×16 grid.

In another embodiment, the CCM information in the current CTU row, or the current CTU row+M CTU rows can be referenced without limits (i.e., unconstrained), and for the to-be referenced positions in the above CTU rows, the positions will be mapped to one line above of current CTU, or the current CTU row+M CTU rows for referencing. This design can preserve most of the coding efficiency and doesn't increase buffer by much for storing the CCM information of above CTU rows. For example, the CCM information in the current CTU row (1310) and the first CTU row above (1312) can be referenced without limits; and for the to-be referenced positions in the above-second (1320), above-third (1322), above-fourth CTU row, and so on, the positions will be mapped to one line (1330) above the above-first CTU row (as shown in FIG. 13). In FIG. 13, A dark circle indicates a non-available candidate 1340, a dot-filled circle indicates an available candidate 1342 and an empty circle indicates a mapped candidate 1344. For example, the non-available candidate 1350 in the above-second (1322) CTU row is mapped to a mapped candidate 1352 in one line (1330) above the above-first CTU row (1312).

In the above example, the region that can be referenced without limits is close to the current CTU (e.g. the current CTU row or the above-first CTU row). However, the region according to the present invention is not limited to the exemplary region shown above. The region can be larger or smaller than the example shown above. In general, the region can be limited to be within one or more pre-defined distances in a vertical direction, a horizontal direction or both from the current CTU. In the above example, the region is limited to 1 CTU height in the above vertical direction, which can be extended to 2 or 3 CTU heights if desired. In the case that left M CTUs are used, the limit is M CTU width for the current CTU row. The horizontal position of a to-be referenced position and the horizontal position of a mapped pre-defined position can be the same (e.g. position 1350 and position 1352 in the same horizontal position). However, other horizontal position may also be used.

In another embodiment, the CCM information in the current CTU row, or the current CTU row+M CTU rows can be referenced without limits. Furthermore, for the to-be referenced positions in the above CTU rows, the positions will be mapped to the last line of the corresponding CTU row for referencing. For example, as shown in FIG. 14, the CCM information in the current CTU row (1310) and the first CTU row (1312) above can be referenced without limits, and for the to-be referenced positions in the above-second CTU row (1320), the positions will be mapped to the bottom line (1330) of the above-second CTU row (1320). For the to-be referenced positions in above third CTU row (1322), the positions will be mapped to the bottom line (1420) of the above-third CTU row (1322). For example, the non-available candidate 1350 in the above-third CTU row (1322) is mapped to a mapped candidate 1430 in the bottom line (1420) of the above-third CTU row (1322). The legend for the candidate types (i.e., 1340, 1342 and 1344) of FIG. 14 is the same as that in FIG. 13. In this example, the unconstrained region may include one or more above CTU rows (e.g. 1 CTU row in FIG. 14). The above-second CTU row is above the unconstrained region. The above-third CTU row is also referred as an above-above CTU row since it is above the CTU row (i.e., the above-second CTU row) above the unconstrained region.

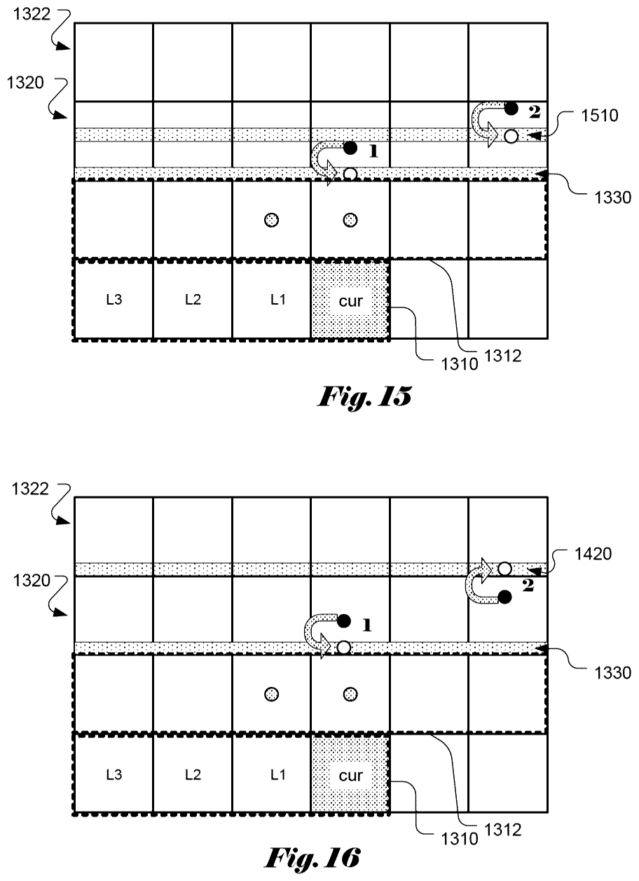

In another embodiment, the CCM information in the current CTU row, or the current CTU row+M CTU rows can be referenced without limits, and for the to-be referenced positions in above CTU rows, the positions will be mapped to the last line or bottom line or centre line of the corresponding CTU row for referencing depending on the position of the to-be referenced CCM information. For example, as shown in FIG. 15, the CCM information in the current CTU row (1310) and the above-first CTU row (1312) can be referenced without limits, and for the to-be referenced position 1 in above-second CTU row (1320), the positions will be mapped to the bottom line (1330) of the above-second CTU row before referring. However, for the to-be referenced position 2 in above-second CTU row, the positions will be mapped to the centre line (1510) of the above-second CTU row (1320) before referring since it is in the top half region of the above-second CTU row (1320) and hence it is closer to the centre line (1510) compared with bottom line (1330). The legend for the candidate types (i.e., 1340, 1342 and 1344) of FIG. 15 is the same as that in FIG. 13.

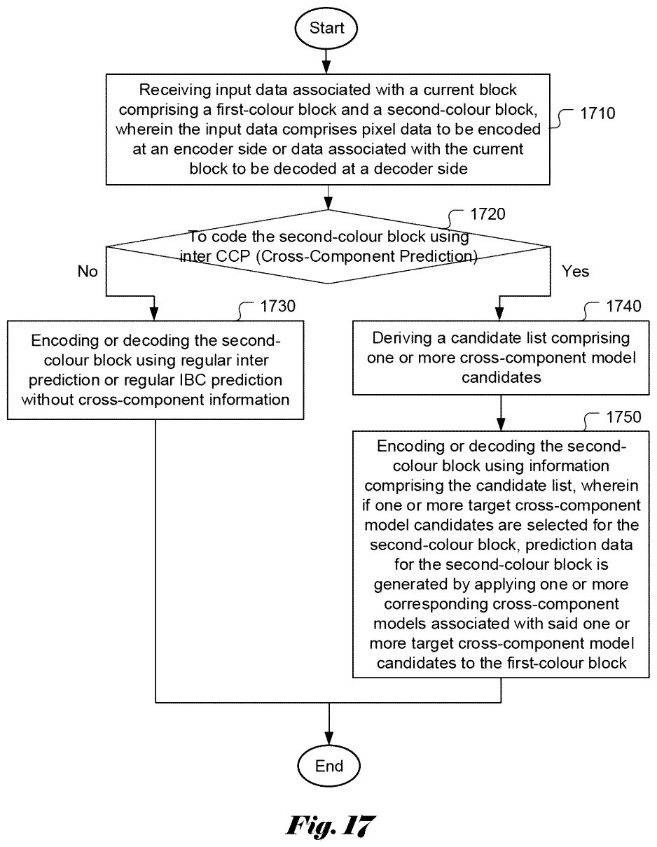

In another embodiment, the CCM information in the current CTU row, or the current CTU row+M CTU rows can be referenced without limits, and for the to-be referenced positions in the above CTU rows, the positions will be mapped to the last line or bottom line of the corresponding CTU row for referencing depending on the position of the to-be referenced CCM information. For example, as shown in FIG. 16, the CCM information in the current CTU row (1310) and the above-first CTU row (1312) can be referenced without limits, and for the to-be referenced position 1 in the above-second CTU row (1320), the positions will be mapped to the bottom line (1330) of the above-second CTU row (1320) before referring. However, for the to-be referenced position 2 in the above-second CTU row (1320), the positions will be mapped to the bottom line (1420) of the above-third CTU row (1322) before referring since it is closer to the bottom line (1420) of the above-third CTU row compared with bottom line (1330) of the above-second CTU row as shown in FIG. 16. The legend for the candidate types (i.e., 1340, 1342 and 1344) is the same as that in FIG. 13.

In another embodiment, the CCM information in the current CTU, or the current CTU+N left CTU can be referenced without limits, and for the left CTUs, the to-be referenced positions will be mapped to the very right line closest to the current CTU, or the current CTU+N left CTU. For example, the CCM information in the current CTU and first left CTU can be referenced without limits, and if the to-be referenced positions are in the second left CTU, the positions will be mapped to one line left to the first left CTU. If the to-be referenced positions are in the third left CTU, the positions will be mapped to one line left to first left CTU.

In yet another embodiment, the CCM information in the current CTU and the first left CTU can be referenced without limits, and if the to-be referenced positions are in the second left CTU, the positions will be mapped to the very right line (i.e., the rightmost line) of the second left CTU. If the to-be referenced positions are in the third left CTU, the positions will be mapped to the very right line to the third left CTU.

In another embodiment, when the available range for including non-adjacent candidates is constrained, if the position of a non-adjacent candidate is outside of the available range, that candidate is skipped and will not be inserted into the candidate list. The available region can be the current CTU, current CTU row, current CTU row+above N CTU rows, current CTU+left MCTUs, or current CTU+above NCTU rows+left MCTUs.

V.7. Inheriting from Fusion Mode

Fusion mode refers to mode that fuses two predictions to generate the final prediction. In the chroma intra fusion mode, a chroma intra prediction that is not generated using a cross-component prediction (CCP) coding tool (e.g., CCLM, MMLM, CCCM) is fused with another chroma intra prediction generated using a cross-component prediction coding tool. For example, a non-CCLM coded intra prediction and a CCLM coded intra prediction are fused together to obtain the final intra prediction.

In one embodiment, when inheriting the cross-component model parameters from the block/position coded by chroma intra fusion mode, the model parameters for obtaining the CCP coded intra prediction are inherited and further refined.

In one embodiment, in addition to inheriting and refining the CCP model parameters, the fusion weight, the coding mode of non-CCP coded intra prediction are also inherited. That is, the chroma intra fusion mode is inherited.

### VI. Constructing a Candidate List

In one embodiment, the candidate list is constructed by adding candidates in a pre-defined order until the maximum candidate number is reached. The candidates added can include all or some of the aforementioned candidates, but not limited to the aforementioned candidates. For example, the pre-defined order can be spatial adjacent candidates, temporal candidates, spatial non-adjacent candidates, historical candidates, and then default candidates.

In another embodiment, if all the pre-defined neighbouring and historical candidates are added but the maximum candidate number is not reached, some default candidates are added into the candidate list until the maximum candidate number is reached.

In one embodiment, the default candidates can be CCLM models. The scaling parameter α is from the set {0, ⅛, −⅛, + 2/8, − 2/8, +⅜, −⅜, + 4/8, − 4/8, . . . +N/8, −N/8}, where N is a positive integer. The offset parameter β can be 1/(1<<bit_depth) or can be derived based on neighbouring luma and chroma samples. For example, if the average value of neighbouring luma and chroma samples are lumaAvg and chromaAvg, β=chromaAvg−α·lumaAvg. In one sub-embodiment, the inclusion order of the default candidates can depend on the absolute value and the sign of the scaling parameter α. For example, the default candidates are added into the list in the following order: α=0, ⅛, −⅛, + 2/8, − 2/8, +⅜, −⅜, + 4/8, − 4/8, . . . +N/8, −N/8.

In another embodiment, a default candidate can be an earlier candidate with a delta scaling parameter refinement. The earlier candidate is a CCLM model. If the scaling parameter of an earlier candidate is α, the scaling parameter of a default candidate is (α+Δα). For example, Δα can be 0, ⅛, −⅛, + 2/8, − 2/8, +⅜, −⅜, + 4/8, − 4/8, . . . +N/8, −N/8, where N is a positive integer. For example, Δα can be 0, ⅛, −⅛, + 2/8, − 2/8, +⅜, −⅜, + 4/8, − 4/8. The offset parameter β can be derived based on (α+Δα) and the average value of neighbouring luma and chroma samples of the current block. In one sub-embodiment, the earlier candidate is the first CCLM candidate added into the list. In one sub-embodiment, the inclusion order of the default candidates can depend on the absolute value and the sign of the refinement Aa. For example, the default candidates are added into the list in the following order: Δα=0, ⅛, −⅛, + 2/8, − 2/8, +⅜, −⅜, + 4/8, − 4/8, . . . +N/8, −N/8.

### VII. Removing or Modifying Similar Neighbouring Model Parameters

When inheriting cross-component model parameters from other blocks, it can further check the similarity between the inherited model and the existing models in the candidate list or those model candidates derived by the neighbouring reconstruction samples of the current block (e.g., models derived by CCLM, MMLM, or CCCM using the neighbouring reconstruction samples of the current block). If the model of a candidate parameter is similar with the existing models, the model would not be included into the candidate list.

### VIII. Reordering the Candidates in the List

The candidates in the list can be reordered to reduce the syntax overhead when signalling the selected candidate index.

In one embodiment, the reordering mles can depend on the coding information of neighbouring blocks or the model error. For example, if neighbouring above or left blocks are coded by MMLM, the MMLM candidates in the list can be moved to the head of the current list.

In one embodiment, the reordering rule is based on the model error by applying the candidate model to the neighbouring templates of the current block, and then compare the error with the reconstruction samples of the neighbouring template.

The term “block” in this invention can refer to TU/TB, CU/CB, PU/PB, or CTU/CTB.

The term “LM” in this invention can be viewed as one kind of CCLM/MMLM modes or any other extension/variation of CCLM (e.g. the proposed CCLM extension/variation in this invention). One variation is MMLM that uses thresholds to decide different models for different samples in the current chroma component. Another variation is that for Cb (or Cr), deriving model parameters from multiple collocated luma blocks. The following show more possible variations. The variations of CCLM here mean that some optional modes can be selected when the block indication refers to using one of cross-component modes (e.g. CCLM_LT, MMLM_LT, CCLM_L, CCLM_T, MMLM_L, MMLM_T, and/or an intra prediction mode, which is not one of traditional DC, planar, and angular modes) for the current block. The following shows an example of being convolutional cross-component mode (CCCM) as an optional mode. When this optional mode is applied to the current block, cross-component information with a model, including non-linear term, is used to generate the chroma prediction. The optional mode may follow the template selection of CCLM, so CCCM family includes CCCM_LT CCCM_L, and/or CCCM_T.

The proposed methods (for CCLM) in this invention can be used for any other cross-component modes.

Any combination of the proposed methods in this invention can be applied.

Any of the foregoing proposed methods of using adaptive interCCP or adjusted interCCP for chroma coding can be implemented in encoders and/or decoders. For example, any of the proposed methods can be implemented in an inter/intra/prediction/IBC/quantization module of an encoder, and/or an inter/intra/prediction/IBC/quantization module of a decoder. Alternatively, any of the proposed methods of using adaptive interCCP or adjusted interCCP for chroma coding can be implemented as a circuit coupled to the inter/intra/prediction module of the encoder and/or the inter/intra/prediction/IBC/quantization module of the decoder, so as to provide the information needed by the inter/intra/prediction/IBC/quantization module.

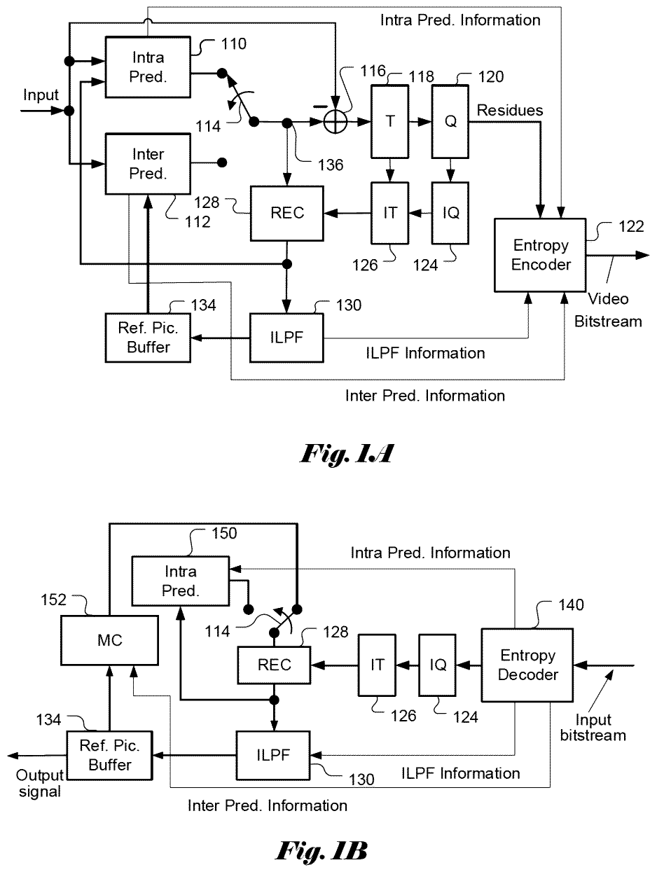

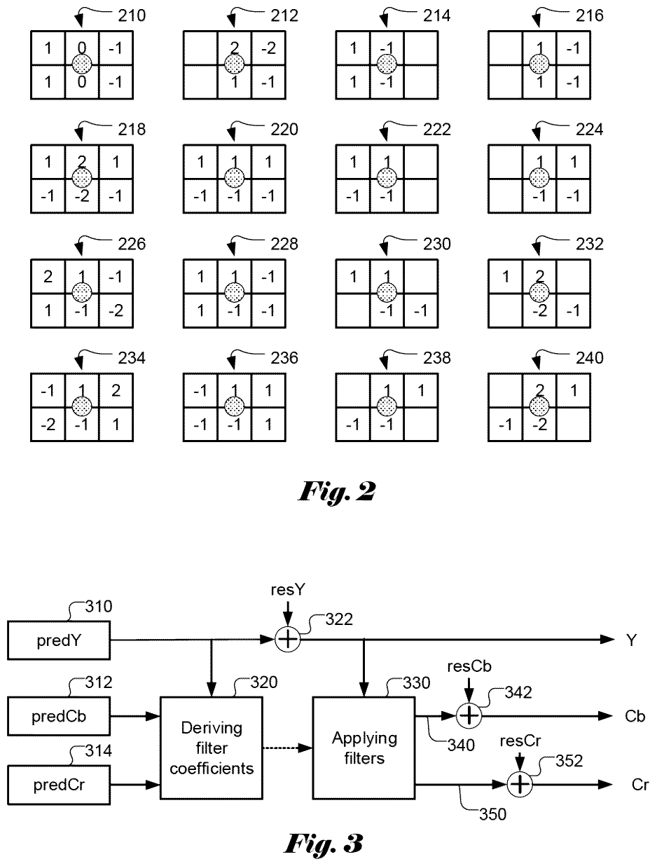

The method of using adaptive interCCP or adjusted interCCP for chroma coding can be implemented in an encoder side or a decoder side. For example, any of the proposed methods of deriving temporal cross-component model information can be implemented in an Intra/Inter coding module (e.g. Intra Pred. 150/MC 152 in FIG. 1B) in a decoder or an Intra/Inter coding module in an encoder (e.g. Intra Pred. 110/Inter Pred. 112 in FIG. 1A). Any of the proposed methods can also be implemented as a circuit coupled to the intra/inter coding module at the decoder or the encoder. However, the decoder or encoder may also use additional processing unit to implement the required cross-component prediction processing. While the Intra Pred, units (e.g. unit 110/112 in FIG. 1A and unit 150/152 in FIG. 1B) are shown as individual processing units, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

FIG. 17 illustrates a flowchart of an exemplary video coding system that uses interCCP (inter Cross-Component Prediction) adaptively for chroma coding according to an embodiment of the present invention. According to this method, input data associated with a current block comprising a first-colour block and a second-colour block is received in step 1710, wherein the input data comprises pixel data to be encoded at an encoder side or data associated with the current block to be decoded at a decoder side. Whether to code the second-colour block using inter CCP (Cross-Component Prediction) is determined in step 1720. If the inter CCP is not applied to the second-colour block (i.e., the “No” path from step 1720), step 1730 is performed. Otherwise (i.e., the “Yes” path from step 1720), steps 1740 and 1750 are performed. In step 1730, the second-colour block is encoded or decoded using regular inter prediction or regular IBC prediction without cross-component information. In step 1740, a candidate list comprising one or more cross-component model candidates is derived. In step 1750, the second-colour block is encoded or decoded using information comprising the candidate list, wherein if one or more target cross-component model candidates are selected for the second-colour block, prediction data for the second-colour block is generated by applying one or more corresponding cross-component models associated with said one or more target cross-component model candidates to the first-colour block.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of coding colour pictures using coding tools including one or more cross component models related modes, the method comprising:
receiving input data associated with a current block comprising a first-colour block and a second-colour block, wherein the input data comprises pixel data to be encoded at an encoder side or data associated with the current block to be decoded at a decoder side;
determining whether to code the second-colour block using inter CCP (Cross-Component Prediction);
in response to the inter CCP being not applied to the second-colour block:
encoding or decoding the second-colour block using regular inter prediction or regular IBC prediction without cross-component information:
in response to the inter CCP being applied to the second-colour block:
deriving a candidate list comprising one or more cross-component model candidates; and
encoding or decoding the second-colour block using information comprising the candidate list, wherein if one or more target cross-component model candidates are selected for the second-colour block, prediction data for the second-colour block is generated by applying one or more corresponding cross-component models associated with said one or more target cross-component model candidates to the first-colour block.

2. The method of claim 1, wherein when the inter CCP is applied to the second-colour block, the first-colour block is coded in the regular inter prediction or in the regular IBC prediction without the cross-component information.

3. The method of claim 1, wherein the inter CCP corresponds to inter CCLM (Cross-Component Linear Model) or inter CCCM (Convolutional Cross-Component Model).

4. The method of claim 1, wherein whether to code the second-colour block using the inter CCP is indicated by signalling.

5. The method of claim 4, wherein said signalling refers to a flag in TU, TB, CU or CB level.

6. The method of claim 5, wherein the flag is signalled only when Cbf (Coding block flag) is non-zero and an enabling flag for the inter or IBC (Intra Block Copy) mode is true.

7. The method of claim 5, wherein the flag is coded using one or more contexts.

8. The method of claim 1, wherein when the inter CCP is applied to the second-colour block, additional signalling is used to select said one or more target cross-component model candidates from the candidate list.

9. The method of claim 8, wherein when multiple target cross-component model candidates are selected, the prediction data for the second-colour block is generated by blending corresponding multiple cross-component models associated with the multiple target cross-component model candidates.

10. The method of claim 8, wherein the additional signalling corresponds to using an index coded by truncated unary coding with or without context.

11. The method of claim 1, wherein the inter CCP is signalled or parsed only when one or more size conditions of the current block are satisfied.

12. The method of claim 11, wherein said one or more size conditions of the current block comprise block width, block height, or block area being larger or smaller than a pre-defined threshold.

13. The method of claim 1, wherein when the inter CCP is applied to the second-colour block, said one or more target cross-component model candidates from the candidate list are determined implicitly or according to one or more rules.

14. The method of claim 13, wherein at least one of CCLM_LT (Cross-Component Linear Model with Left and Top templates), MMLM_LT (Multi-Mode CCLM with Left and Top templates), and CCCM_LT (Convolutional Cross-Component Model with Left and Top templates) is always used as said one or more target cross-component model candidates.

15. The method of claim 13, wherein said one or more rules are determined depending on block width, block height, or block area.

16. The method of claim 13, wherein said one or more rules are determined depending on boundary matching.

17. The method of claim 1, wherein one target cross-component model candidate is selected from the candidate list, and the prediction data is blended with second prediction data corresponding to an angular or planar mode to form final prediction data for the second-colour block.

18. The method of claim 17, wherein an index is signalled or parsed to indicate said one target cross-component model candidate selected from the candidate list.

19. The method of claim 1, wherein whether the inter CCP is used in the current block is determined depending on an enabling flag.

20. The method of claim 19, wherein the enabling flag is signalled or parsed in a bitstream, or is inferred.

21. The method of claim 20, wherein whether to signal or parse the enabling flag is determined dependent on block width, block height, or block area.

22. The method of claim 19, wherein the enabling flag is regular merge flag when the current block is coded in a regular merge mode.

23. The method of claim 19, wherein the enabling flag is CIIP (Combined Inter and Intra Prediction) flag when the current block is coded in a CIIP mode.

24. The method of claim 19, wherein the enabling flag is CIIP (Combined Inter and Intra Prediction) PDPC (Position Dependent Prediction Combination) flag when the current block is coded in a CIP PDPC mode.

25. The method of claim 1, wherein a combined predictor for the second-colour block is derived by combining at least one of the regular inter prediction and the regular IBC prediction with the prediction data from the inter CCP, wherein said at least one of the regular inter prediction and the regular IBC prediction is adjusted based on neighbouring data and pre-defined weighting before said combining said at least one of the regular inter prediction and the regular IBC prediction with the prediction data from the inter CCP.

26. The method of claim 25, wherein the pre-defined weighting follows PDPC (Position Dependent Prediction Combination) weighting.

27. An apparatus for coding colour pictures using coding tools including one or more cross component models related modes, the apparatus comprising one or more electronic circuits or processors arranged to:
receive input data associated with a current block comprising a first-colour block and a second-colour block, wherein the input data comprise pixel data to be encoded at an encoder side or data associated with the current block to be decoded at a decoder side;
determine whether to code the second-colour block using inter CCP (Cross-Component Prediction);
in response to the inter CCP being not applied to the second-colour block:
encode or decode the second-colour block using regular inter prediction or regular IBC prediction without cross-component information;
in response to the inter CCP being applied to the second-colour block:
derive a candidate list comprising one or more cross-component model candidates; and
encode or decode the second-colour block using information comprising the candidate list, wherein if one or more target cross-component model candidates are selected for the second-colour block, prediction data for the second-colour block is generated by applying one or more corresponding cross-component models associated with said one or more target cross-component model candidates to the first-colour block.
